(19) United States
(12) Patent Application Publication
(10) Pub. No.: US 2005/0198163 A1
(43) Pub. Date: Sep. 8, 2005

(54) Method and apparatus for teaching about conception of power

(76) Inventor: C. Cryss Brunner, Minneapolis, MN (US)

Correspondence Address: Schwegman, Lundberg, Woessner & Kluth, P.A., P.O. Box 2938, Minneapolis, MN, 55402, US

(21) Appl. No.: 10/967,659

(22) Filed: Oct. 18, 2004

Related U.S. Application Data
(60) Provisional application No. 60/512,013, filed on Oct. 16, 2003.

(51) Int. Cl. G06F 15/16

(52) U.S. Cl. 709/206

(57) ABSTRACT

Method and apparatus for using computerized chat rooms to allow participants to interact with one another without revealing to other participants their true identity, wherein participants are given pseudo identities that are presented to other participants during a training exercise, and wherein the pseudo identities are revealed in one or more stages.

### TECHNICAL FIELD OF THE INVENTION

The present invention pertains generally to education and training, and more particularly to an electronic system for use in teaching how conceptions of power affect communication and behavior.

### BACKGROUND OF THE INVENTION

The way in which power is wielded in an organization is known to be dependent on perceptions of the position, race, and/or gender of the organization's members. Training tools which educate an organization's members on how these perceptions affect leadership can therefore help increase access for underrepresented groups to work environments in which they would normally feel alienated.

### DETAILED DESCRIPTION OF THE INVENTION

According to one embodiment of the inventive subject matter disclosed herein, there is provided a system and method for using computer technology to modify a person's appearance to get a different response from an audience than would be obtained if the audience knew the person's actual appearance, and having the person with the modified persona learn lessons pertinent to democratic cultures and social justice, from their experience of immersion in that response.

According to one embodiment of the inventive subject matter disclosed herein, there is provided system and method to perform the following method:

1. Before classes begin, participants are interviewed individually by the instructor and asked to answer questions aimed at determining individuals' conceptions of power and its use. These questions may be, for example, grounded in Brunner's (see 2002) research on power. During the interview, participants are informed that their identities will be masked in multiple ways during the chat sessions.

2. During the first third of the course, MP participants meet in carefully designed chat room experiences that immerse them in policy decision-making processes that are a part of addressing and accomplishing a specific problem-based task.

3. The participants experience five identity shifts during the three on-line sessions. These five shifts are listed below:
a) For the first four to five-hour chat session, identities of all participants are completely hidden. Each participant is indicated in the chat space by either a letter or a number. All communications are in writing and participants are instructed to keep their identities hidden by omitting any information that might reveal anything about them.
b) Right after the first session, participants are directed to a private messaging tool where they respond to questions about power, decision-making, identity, and the task on which they are working. The answers to these questions are sent privately to the professor. [Note: Between and during online chat sessions, participants answer reflective questions focused on power dynamics, identity constructions, the process of decision-making during task work, and their own role and actions during the sessions. In order to answer some of the questions, they are required to analyze the transcripts from each of online sessions. They also are asked to read articles that are appropriate for the work online.]
c) Once the answers to the first question sets are in (mid-week after the first session), participants are directed to a time-released website where they can see the pictures of their classmates-all pictures of which are pseudo with the exception of their own. After viewing the pictures, participants are then directed to a second set of questions related to power, identity, and decision-making.
d) During the second chat session, participants are directed to hang the pseudo photos somewhere close to the computer screen so they can be viewed during the chat. After the chat, once again, participants are directed to a third set of questions on power, identity, decision-making, and the task.
e) Once the third set of questions are sent to the professor, participants are directed to a website where they can view video clips of each of the pseudo participants. They are also able to view the video they made at the interview session (no one else can view the video). After viewing the videos, participants are directed to question set four. The questions are focused on the same topics of the other sets. There are additional questions about how voices create the identity of a person.
f) After the third set of questions are answered, participants are then directed to yet another video. In this clip, they can see the video of the pseudo participant who represented them all along. At this point, they understand that they have been represented by someone unlike themselves in various ways. The pseudo representatives have been randomly assigned to represent the real participants in this version (there are many other possibilities including the opportunity for participants to choose their own pseudo representative).
g) The third chat session is conducted. About one hour before the end of this final session, the participants are directed to yet another photo page. This final photo page has the real pictures of the participants. Participants are directed to print the page and hang it up on their computers. They then return to the chat space and discuss their reactions to the latest photos. After the session is over, they are directed to answer questions on the same topics of focus.
h) The fourth class session is face to face. Participants are instructed to sit in the order of their photos and asked not to speak until about an hour into the class. They are asked to answer questions in writing about their reactions to their fellow participants and the experience of seeing them for the first time.

Thus, as described above, there is provided an experiential simulation involving he immersion of participants in an environment in which they are perceived by the others in the environment as having an identity unlike their “true” identify. For example, women may be men or whites may be people of color. The altered identity reflects a gender/racial/class/positional identity other than that to which they are accustomed. While interacting with others in this virtual environment, participants “walk in the shoes” of someone who has been constructed differently from themselves. According to one example embodiment, the interactions occur in carefully designed leadership/policy forming situations, intended to illustrate how perceptions and understandings of others' identity shapes the way leaders enhance or restrict others' participation in decision making. At the same time, through private communication with the instructor, course participants reflect on questions the instructor poses related to identity (gender, race, class, etc.) constructs, power conceptions, and the decision-making processes at play with the group.

According to an alternate embodiment, participants are provided software tools to create software avatars that can be tried in various settings, such as international settings where they do not speak the dominant language very well. Further, in another alternate embodiment, the system and method of the embodiments described herein may be used for actual work settings such as selection processes where equality is an issue or even when real work needs to be accomplished without hierarchy present. It is further noted that the work of the experience can be varied easily. For example, the system and method may be used in two very different courses where the content that participants are learning is very different. In this regard, the participants learn specific content while experiencing a shift in their own identity.

According to still another alternate embodiment of the inventive subject matter described herein, the systems and methods can be implemented using standard online course development tools-web site, chat room, threaded discussion, video and audio clips.

According to still another alternate embodiment, the systems and methods described above may be applied to teleconferencing, but with modified appearance (MP) as described earlier. The canonical example here would consist of having people attend meetings with gender MP (i.e. with their apparent gender being potentially modified) or having people having race MP working together in settings that are typically stratified by race. To be sure, a shift in the way in which power is wielded due to position, race, and/or gender in organizations is to be expected if MP interactions are adopted. The potential exists for creation of a much more democratic, inclusive forum for discussions and meetings, where personal identity, position, race, and gender are removed or altered as factors. This forum can support a highly collaborative form of leadership in which all the participants have an opportunity to be heard and experience equality as much as possible.

A second venue for MP immersion is in the development of leadership with the aim of enhancing the effectiveness of training for all groups—with an emphasis on increasing access for underrepresented groups to work environments in which they would normally feel alienated. An example of this application would consist of allowing girls to visit engineering plants in virtual reality. This would presumably involve presenting the girls as being male; and presenting a substantial fraction of the engineers with whom they interact as being female.

Thus, as described herein the inventive subject matter, according to one aspect, provides for using computer technology to modify a person's appearance, and in particular modifying a person's appearance to get a different response from an audience, and having the person with the modified persona learn lessons pertinent to democratic cultures and social justice, from their experience of immersion in that response.

According to still further embodiments, please refer to Appendix A hereto which is hereby incorporated in its entirety herein.

### Appendix A

Transforming Leadership Preparation for Social Justice: Dissatisfaction, Inspiration, and Rebirth—An Exemplar

C. Cryss Brunner, University of Minnesota-Twin Cities
Karen Hammel, University of Minnesota-Twin Cities
Michael D. Miller, University of Minnesota-Twin Cities
The projects that we feature . . . reflect the sweeping visions of designers and architects whose job, in a sense, is to be dissatisfied with what has come before: [the] old and inappropriate . . . . Each project . . . represents some sort of radical transformation [our emphasis]; but only once a year do we show you the . . . stages of this amazing process. We do it to remind you that no project is hopeless, no task too overwhelming. [Anything] that seems beyond redemption is, in fact, capable of being dramatically reborn. Such transformations may begin with dissatisfaction, but they always end with well-deserved pride. Between the two comes inspiration—which is what we're offering here. (Paige, 2003, p. 38)

In education, we are not lacking dissatisfaction—dissatisfaction with schools, teachers, administrators, and even with the reform efforts meant to correct our dissatisfactions. In fact, contemporary public school reform focused on high achievement for every child began as early as 1970 and continues today. And while “criticism of the ways in which men and women are prepared for school leadership positions enjoys a long history” (Murphy, 1992, p. 79), a critical eye was not turned on educational administrators in light of their connection to reform, or on their preparation programs as related to reform until the mid-1980s (Griffiths, 1988; Griffiths, Stout, & Forsyth, 1988; Murphy, 1992; Peterson & Finn, 1985). Once under scrutiny, preparation programs were found seriously wanting (see Campbell, Fleming, Newell, & Bennion, 1987; Cooper & Boyd, 1987; Culbertson, 1964; Farquar, 1977; Glass, 1986; Gregg, 1969; Hallinger, Leithwood, & Murphy, 1993; McCarthy, 1999b; Moore, 1964; Murphy, 1990, 1991, 1992; Silver, 1982).

The primary reason for the eventual attention on educational leadership preparations programs was the broad-based agreement that because school leadership roles affect participant learning, achievement for each child should be central to their purpose (Cambron-McCabe, 1993; Leithwood, 1994; Yukl, 1994). Thus, it is not surprising that standards-based reform initiatives have spread from standards for participants to standards for teachers and administrators (McCarthy, 1999a). As a result, educational leadership preparation programs are under pressure to produce administrators who can lead reform that equalizes and improves education for all participants (Kohn, 1998; Peebles, 2000). In no small measure, preparation programs need transformations that help rectify dissatisfactions with school leaders. To that end, this chapter will focus on an innovative approach to leadership preparation that results in the dramatic shift in thinking necessary for administrators and others (Nadler & Tushman, 1995; Heifetz & Laurie, 1997) to co-create democratic, socially just learning organizations (Beck & Murphy, 1997; Peebles, 2000)—organizations in which shared, participatory decision-making occurs (Anderson, 1998; Leithwood & Duke, 1999).

Thus, the threefold purpose of this chapter is to a) identify a particular dissatisfaction with school leaders, b) describe an innovative approach—inspired by social justice—to this dissatisfaction, and c) highlight evidence that the approach provides an experience of rebirth or change for participants. For our discussion, we organize the chapter using the three stages of radical transformation identified in the chapter's beginning quote—dissatisfaction, inspiration, and rebirth.

### The First Stage-Unyielding Dissatisfaction: The Challenges of Shared Decision-Making

In our quest for transformed leaders and preparation programs we find ourselves in the first broad stage of radical transformation—dissatisfaction. In order to discuss this first stage, we narrow our focus to a particular dissatisfaction—authentic participatory decision-making—that remains an important, yet unsuccessful part of reform efforts that advance social justice.

On one hand, some educational literature suggests that shared decision-making supports social justice. For example, Gary Anderson (1998) states that “many advocates of poor and disenfranchised groups claim that participation of any form holds out the possibility of greater accountability from educational institutions that have tended to at best ignore them and at worst pathologize them” (p. 582). On the other hand, Anderson (1998) continues, some researchers at more micropolitical levels have provided documentation of the “ways participation is subverted even when diverse groups are brought to the table (Henry, 1996; Malen, 1994; Malen & Ogawa, 1988: Mann, 1974)” (p. 582).

In their study, Malen and Ogawa (1988) found that even under ideal conditions in which teachers and parents should have been able to have substantial influence on significant decisions, the following occurred:
First, although the site councils are authorized policymakers, they function as ancillary advisors and pro form a endorsers. Second, teachers and parents are granted parity, but principals and professionals control the partnerships. Third, although teachers and parents had access to decision-making arenas, their inclusion has maintained, not altered, the decision-making relationships typically and traditionally found in schools. (p. 256, cited in Anderson, 1998, p. 582)
   Thus, research documents the misuse and ineffectiveness of shared decision-making (see also, Delpit, 1994; Oakes, 1985; Popkewitz, 1979; Weiler, 1990) in its various forms, including the problems related to site-based management (SBM) (see Kahne, 1994; Malen & Ogawa, 1988; Newmann, King, & Rigdon, 1997). Several concerns with shared decision-making, identified by research, are related to power relationships and the redistribution of decision-making authority (Malen & Ogawa, 1988; Malen, Ogawa, & Kranz, 1990; Ogawa, 1994; Reitzug & Capper, 1996; Wohlsetter, Symer, & Mohrman, 1994). In the face of this documentation Anderson (1998) suggests, “the discourse of participation has been absorbed into educational institutions in ways that are often manipulative and nondemocratic” (p. 586). And yet, he continues:
I am not arguing that this cooptation of participatory discourse for nondemocratic ends is always done with Machiavellian intentionality. In many cases, attempts at increased participation are sincere but poorly conceived and implemented or caught up in a larger institutional and societal logic that is antithetical to norms of participation. Shifting our notions of participation may require not only understanding the contradictions, inauthenticities, and ideological agendas of the current discourse of participation but also creating new discourses that address broader democratic issues of social justice and are do-able, in the sense that they address current barriers to participation at both micro and macro levels. (p. 586)
   In the remainder of Anderson's (1998) insightful article, he outlines a framework for moving toward what he refers to as “authentic participation” (p. 587). His framework consists of five central questions:
(a) Participation toward what end? (b) Who participates? (c) What are relevant spheres of participation? (d) What conditions and processes must be present locally to make participation authentic (i.e., the micropolitics of participation)? (e) What conditions and processes must be present at broader institutional and societal levels to make participation authentic (i.e., the macropolitics of participation)? (p. 587)

In a discussion of the fourth question—“What conditions and processes must be present locally to make participation authentic?”—Anderson (1998) states, “Lipman (1997) found that participatory school restructuring cannot transform the educational experiences of marginalized participants unless changes occur at both personal and societal levels. She argues that educators' beliefs and assumptions, as well as relations of power in schools and communities, must be challenged” (p. 591). Anderson continues by quoting from Lipman (1997) who wrote,
Without multiple voices, without authorization and support to reexamine critically the very core of beliefs and practices related to disempowered participants, without a public agenda which challenged the culture and power of dominant interests, teachers had few tools to begin to critically examine prevailing ideologies and political and structural arrangements. Thus, race and class divisions, exclusion, silencing, and lack of engagement across differences were seemingly unmitigated by new opportunities for collaboration. (p. 32)
   Opportunities for collaboration do not necessarily in themselves support social justice. Other things must occur. To begin, we agree with Lipman (1997) when she asserts that school leaders' personal beliefs and assumptions be critically challenged in light of ones that support authentic participatory reform and socially just decision-making processes. Going further, we advance that school leaders need targeted learning opportunities and experiences aimed at evoking deep essential insights for particular ontological shifts. In short, a capacity for social justice including authentic participatory decision-making relies on transformed foundational beliefs. The next section describes an innovative leadership preparation approach that provides experiences designed to encourage ontological shifts in its participants.

### The Second Stage—Inspiration: A Promising Innovation¹

1. Portions of this discussion are taken from Brunner, Hitchon, & Brown, (2002).

Increasingly, those involved in research and training in educational leadership have acknowledged the need for better information on how expert school leaders think about what they do. This is essential to understanding the conditions under which they take action, a prerequisite to the design of effective training. (Hallinger, Leithwood, & Murphy, 1993, p. 71)

Often literature that focuses on educational leadership preparation or development, as well as the fundamental cognitive changes required for people to become the type of leader needed in today's schools, ends with the question: What must preparation programs include that will change people from what they are to what they must become? Other literature works to answer this question by advancing that leadership preparation itself must move from the past decades' major paradigm that cast leaders as managers. Instead, it is suggested, principals and other administrators need preparation experiences that transform them from “individual people, role” and “a discrete set of individual behaviors” (Lambert, 1998, p. 6) into capacity builders who hold the aim of shared leadership (Pebbles, 2000). The message is clear, leadership preparation programs need to provide experiences that transform participants for the type of “leadership that represents the transcendence of self-interest by both leader and led” (Burns, 1978; cited in Leithwood & Jantzi, 1999, p. 453).² To be sure, “[t]ransformational approaches to leadership have long been advocated as productive under conditions fundamentally the same as those faced by schools targeted for reform (Leithwood, 1994; Yukl, 1994). There is considerable evidence that transformational practices contribute to the development of capacity and commitment (e.g., Yammarion, Dubinsky, & Spangler, 1998)” (Leithwood & Jantzi, 1999, p. 452). But, how are preparation programs going to provide the transformational experiences that this literature describes?

2. It is not the intent of this chapter to review the literature on “transformational leadership.” For a brief, yet fairly comprehensive summary, see Leithwood and Jantzi (1999). On page 453, for example, they write: Current educational leadership literature offers no unitary concept of transformational leadership. Kowalski and Oates (1993), for instance, accept Burns' (1978) original claim that transformational leadership represents the transcendence of self-interest by both leader and led. Dillard (1995) prefers Bennis' (1959) modified notion of “transformative leadership—the ability of a person to reach the souls of others in a fashion which raises human consciousness, builds meanings and inspires human intent that is the source of power” (p. 560). Leithwood (1994) used another modification of Burns, this one based on Bass's (1985) two-factor theory in which transactional and transformational leadership represent opposite ends of the leadership continuum. Bass maintained that the two actually can be complementary. Leithwood (1994) identified six factors that make up transformational leadership. Hipp and Bredeson (1995), however, reduced these factors to five in their analysis of the relationship between leadership behaviors and teacher efficacy. Gronn (1996) noted the close relationship, in much current writing, between views of transformational and charismatic leadership, as well as the explicit omission of charisma from some current conceptions of transformational leadership.

In response to this question, we are in the beginning stages of retooling leadership preparation programs to provide the transformational experiences aimed at building the authentically-participative, decision-making capacity within school leaders, As stated in Brunner, Hitchon, and Brown (2002),
[t]he primary purposes of this project are: (a) to address the current concerns about the misuse and ineffectiveness of shared decision-making, specifically ones related to power relationships, [constructions of identity], and the redistribution of decision-making authority through the development of, what we refer to as, technologically delivered Experiential Simulations (ES); and (b) to change the face of higher education preparation programs to meet and adapt to the challenges of the future. For as Schank (2002) suggests, “The virtual schools that will arise to take the place of current institutions will attract participants less because of the credentials they bestow than because of the experiences they offer” (p. 211). In particular, we are convinced that in order to facilitate participatory school restructuring, educational leaders need targeted and personal learning opportunities—delivered through ES in virtual school—to develop the insights and skills necessary to create and support collaborative practices and decision-making spaces in which all community members are included—practices and spaces in which leaders' understandings of power are conceptualized as shared rather than as over others. (p. 12-13)

In order to achieve the first aspect of our purposes, we have developed the Experiential Simulations (ES) previously mentioned. In these pursuits, we have joined others who are evaluating current technological developments that allow individuals to interact in virtual reality (Kopernik et al., 1997; Massaro et al., 1998; Morishima et al., 1990; Scott & Leong, 2000; Tabor, 1997).

Our research-based work is grounded in theoretically driven classroom experiences and exercises developed between 1994-1999 (for full discussion, see Brunner, 2002). In the past, in order to teach about conceptions of power and their inter- and intra-relationship to constructions of difference and collaborative decision-making during courses, Brunner led participants through classroom-based experiences in which participants uncovered their own conceptions of power. In addition, participants were asked to creatively alter their own personal backgrounds (education, family, occupation) in order to escape constructions of difference/identity related to these pieces of background information. These classroom activities, while successful at some levels, were limited by the physical presence of the participants. Constructions of difference/identity (related to gender, race, class, and other categories of difference) and assumptions about power—within decision-making settings—were more difficult to unpack and make explicit in order to set them aside.

Because of the difficulties noted above, to develop the ES we have taken advantage of the computer's visualization capabilities to a) keep individual's identities hidden and b) present individuals to others with a Modified Persona (MP). There is little doubt that position/race/gender plays an enormous role in how we respond to each other (See Larson & Ovando, 2001). In fact, our evaluations have shown that even when all parties are aware (as a part of informed consent) that their identities are being altered their interactions differ substantially when their positions, race, and/or gender are completely hidden or appear to each other to be modified.

Using standard online course development tools—web site, chat room, threaded discussion, and video and audio clips—an instructional plan was developed in which course participants, first with real identities masked and later altered completely, met online for the first third of the course to collaborate on an assigned decision-making task (the simulation).

The Experiential Simulations involve the immersion of participants in an environment in which they are perceived by the others (in the environment) to have an identity unlike their true identify [e.g., women may be men; whites may be people of color]. The altered identity reflects a gender/racial/class/positional identity other than that to which they are accustomed. While interacting with others in this virtual environment, participants walk in the shoes of others whose social constructions are different from their own. Or stated in another way, not only are participants' social constructions newly different, but also, participants may be perceived differently as a result of “the others” social construction of them.

Participants' interactions occur in carefully designed leadership/policy forming situations, intended to illustrate how perceptions and understandings of others' identity shape the way leaders enhance or restrict others' participation in decision-making. At the same time, through private communication with the instructor, course participants reflect on questions posed related to identity (gender, race, class, etc.) constructs, power conceptions, and the decision-making processes at play with the group.

In brief, the design of the ES described in this chapter, consists of several steps (full details are too extensive to include in this chapter):

1. Before classes begin, participants are interviewed individually by the instructor and asked to answer questions aimed at determining individuals' conceptions of power and its use. These questions are grounded in Brunner's (see 2002) research on power. During the interview, participants are informed that their identities will be masked in multiple ways during the chat sessions.

2. During the first third of the course, modified persona (MP) participants meet in carefully designed chat room experiences that immerse them in policy decision-making processes that are a part of addressing and accomplishing a specific problem-based task.

3. Between and during online chat sessions, participants answer reflective questions focused on power dynamics, identity constructions, the process of decision-making during task work, and their own role and actions during the sessions. In order to answer some of the questions, they are required to analyze the transcripts from each of online sessions. They also are asked to read articles that are appropriate for the work online.

4. Online class sessions are followed by face-to-face sessions.

5. At the end of the course, individual exit interviews are conducted by the instructor. Questions are open-ended and focused on gaining insights into participants' understandings and critique of the course experiences.

In the last section of the chapter, narrative from one participant who experienced the innovative preparation program offers evidence that the inspired, innovative approach has potential to radically transform leaders' thinking about power and decision-making and to rebirth them in ways that support socially just, authentically participative leadership.

### Stage Three—Rebirth: An Exemplar of Radical Transformation

In this leadership (superintendency) preparation class, technology closed the gap between the dissatisfaction with current preparation programs and the necessary rebirth of educational leaders. The class combined technology with sound theoretical principles of transformation—anticipation, absence of control, and reflection (Wong, Packard, Girod, & Pugh, 2000)—to create the acquisition of new knowledge. As one participant, Kelly (pseudonym), recalled, “I logged on not knowing what to expect. I had read the ‘task’ and thought little of it.” In this section, testimony based on the experience of Kelly provides an exemplar to illustrate how her deeply seated, ontological conceptions of power were challenged to the extent that she felt a strong need to change—she became dissatisfied with her own practices during decision-making sessions.

To begin the preparation process, one-on-one interview/informational meeting's between each participant and the professor and individual technology orientations prior to the first scheduled on-line meeting created the sense of anticipation for participants that is essential for transformation. The anticipation resulting from condensed course information along with technology-related anxiety introduced the tenet that control would not be owned by either participant or professor throughout much of the program. While in the chat space, Kelly strongly felt the lack of ownership, even her own. As she stated:
Surely Cryss would be using [the task] in some interesting way to get us to think about leadership. But I was wrong. Cryss, it turns out, was absent altogether. I took this class to learn from her, to be challenged by her! But she was nowhere to be found except snippets of rules and prompts to take a break. Hell of a lot of good that was. Worse yet, everyone seemed to be taking this task very seriously, as if that is what they came for! What the hell were they thinking? Who gives a rip about some fictional district with some fictional crisis? Surely not me.
   In addition to lack of ownership, the apriori and then later experiential understanding that the course environment relative to identity was in motion was the catalyst that moved participants to experience the opposite of control (Wong et al., 2001). It was upon experiencing “the opposite of control” that Kelly moved into the first stage of radical transformation—dissatisfaction. She pointedly describes her feelings,
I remember crawling into bed that night feeling so tense and tired. The chat session, though unproductive, took a great deal out of me and I couldn't figure out why. I told my husband that it was awful, and that I was awful in return. I don't like what I turned into there, I would tell him. I wanted to be funny and lighthearted, but people took it as sarcastic and caustic. I wanted to help, but no one listened, so I got loud and abrasive. I wanted to be done, but no one responded, so I offered to just do it myself. I thought I had made some good contributions, but they were tossed aside when “O” [the letter given one participant instead of a name; all participants we given a letter of the alphabet] the great goddess of goodness and light came on the scene to rescue everyone. I didn't like the shame that came over me as I thought about who I was, and how I had nothing truly valuable to contribute.

While terms such as learner preference and self-determination have long held places in the ranks of constructivist teaching principles, seemingly, less attention has been given to its invaluable counter part, “‘opposite of control.’ We . . . make the point that transformative experience . . . can only occur when the distance and distinction between person and world decreases, rather than increases” (Wong et al., 2001). For as Dewey, (1934; cited in Wong, Packard, Girod, & Pugh; 2000) stated:
The uniquely distinguishing feature of esthetic experience is exactly the fact that no such distinction of self and object exists in it, since it is esthetic in the degree to which organisms and environment cooperate to institute an experience in which the two are so fully integrated that each disappears. (p. 6)
   Thus, opposite of control is defined as one's acceptance that external forces outside of one's own intention continuously change rather than the belief that one has no control (Wong, Packard, Girod, & Pugh, 2000, p. 317). Described by the alpine skier who with gravity's momentum travels across the mountain's contour; it is the space occupied when external forces acting upon a person harmonize with their level of intentional exploration. Again, Dewey (1934) from Wong, Packard, Girod, and Pugh (2000),
The esthetic or undergoing phase of experience is receptive. It involves surrender. But adequate yielding of the self is possible only through a controlled activity that may well be intense. In much of our intercourse with our surroundings we withdraw; sometimes from fear, if only expending unduly our store of energy; sometimes from preoccupation with other matters, as in the case of recognition. Perception is an act of the going-out of energy in order to receive, not a withholding of energy. To steep ourselves in a subject-matter we have first to plunge into it. When we are only passive to a scene, it overwhelms us and, for lack of answering activity, we do not perceive that which bears us down. We must summon energy and pitch it at a responsive key in order to take in. (p. 53)
   Kelly moved quickly into the undergoing phase of the experience. She talked about her surrender to the intense, controlled activity,
Despite my attempts to draw allies and support for my behavior in the chat room, no one was willing to team up. No one would tell me who they were. No one was willing to plot a course of action to carry into the next week so we could complete the task and get on with it. Every one of them was irritated; every one of them spoke negatively about that first night. They all dealt with it differently than 1 wanted to, though. They maintained a commitment to Cryss's plan, where I was quite done with Dr. Brunner and her stupid class, thank you very much. Sadly, then, without the support of my cohort, I remained alone.
   Because the on-line meetings of the superintendency preparation class were characterized by a chat space saturated with possibilities; amplified by virtue of being without voice, context or identify, through the hours and sessions to come, participants surrendered to the anonymity posed by technology while at the same time, acting upon it. Kelly spoke clearly about her efforts to act upon the experience,
I went into the second week ready to sit back. I was going to do nothing, say little. I would contribute my summary and stand back. That plan didn't work well. I couldn't do it. I could not shut up. I told myself that I could not sit by and waste this class while everyone else goofed around and had a big group hug. So week two went by much like the first. The task was coming together slowly, “0” saved the group from certain death, and I was put in my place on occasion for being mean. I had the same resentments, the same conversations with my husband and continued to pursue my cohort to support me—with the same result.
   During the chat sessions, participants openly debated ideals of leadership and other issues related to the task at hand, while allowing their internal beliefs to unfold. As opportunities for reflection grew, participants faced various personal truths for the first time. In the end the true test of transformation rested upon each participant's ability to expose and her/his readiness to reflect on what each saw. At this stage, Kelly began to understand what the process invited. She explained, “There was no real excuse for my behavior. There was no reason for getting angry. There was only me. I was starting to get it, that I was creating my own experience, and I felt very alone.” Kelly continued with further reflection:
Most often when I am alone I know the person I'm with. I have clear views of [Kelly] the professional, [Kelly] the teacher (who is different, by the way), [Kelly] the friend, the wife, the mother, the student. I am many, many different things. I was comfortable being many different people. And they are very different. People who know me as a Mom would be shocked at the way I run over people at work. And people at work assume I am a cold disciplinarian with total control over my husband and children. When I speak of it to myself, I am comforted those distinctions. Sometimes I think it's plain old fun, like acting or playing a game. I know that either way my heart is protected. I am nurtured and loved so beautifully at home, and I do not want that vulnerability at work. The dangers are too great. This plan was working for me.
   Clearly, the Experiential Simulations offered densely packed experiences during long on line sessions. The final component of transformation critical to the program was the opportunity to reflect. Participants were asked to analyze the transcripts of chat/decision-making sessions and document their reflections through question sets to the instructor. After her analysis of the transcripts, Kelly reflected that:
At any time, I could have chosen to be positive, to shut my mouth, to lift someone up, to ask good questions or just walk away. But I did not. I was a leader in that chat space. I exercised a great deal of influence. I truly feel that because of my own forceful personality, I was the most offensive and hurtful person there. I really am a leader. And I am ashamed of the way I lead . . . . I am an administrator. People look to me for guidance and example. And they see anger and force and power mongering. They see me.

At the conclusion of the on-line portion of the class, participants met in face-to-face classes promoting further release of significant inter and intra-personal findings about leadership and power through discussion and presentation. Kelly expressed her inner struggle as face-to-face classes took place:
I cannot simply be me and take responsibility for that because I hurt people. I cannot be someone else, because I don't know how. I have to be someone different, yet I am not ready to face that or come to terms with what that would mean.
   Because she had been successful in her career, it was doubly difficult for Kelly to think about a change. This is not an unusual set of circumstances for educational leaders. Change can be dangerous, especially if one has been successful (by whatever measure) in the past. Kelly, who was a newly hired administrator at the time of the class, talked about this tension:
I did a great job. I am a highly skilled teacher. I am able to handle and welcome every participant who walks into my classroom. I love teaching. I know Due Process and Special Education Law better than anyone I know. I have recruited and mentored new staff. I have contributed tirelessly to the development of a broad spectrum of inclusive services for Special Education students. I was active on countless committees. I brought in grants to finance my vision of services. Whenever I asked something of the director of special education or the principal, I almost always got it. I became very powerful and, I believe, respected in my role. Things were looking really good!
   Upon her experience in the class, Kelly moved beyond her defense of her past practice. As she put it,
I was ashamed of my behavior, my attitude, and my lack of respect for others . . . I was ashamed that, not only could I identify just one other person in that chat room, I did not care to know the others. I was ashamed that intelligence was not enough. Sarcasm and wit were not enough. The willingness to work harder and faster than anyone else was still [original emphasis] not enough. The only conclusion that I could possibly draw was that I was not enough. For a superhero, that was a defeating blow . . . I cannot imagine another setting where I would have failed so bitterly. I have been, by most accounts quite successful. For whatever reason, I had been rewarded richly in my professional life.
   In fact, once willing to let go of her defense of past practices, Kelly moved further. She remembers:

I began to reach out a little. I engaged in side conversations with cohort members in the class. I tried to be so casual, like it was nothing really, but “I feel like this . . . ” To my surprise, I found someone who had felt the same way. It was not the class that brought her to this same place, but she knew what I meant. She wanted to get together and talk about it sometime, with others as well. She knew that it was a lonely and difficult journey. And the cloud began to lift. It was that ten-minute conversation at break that made all the difference. From that point on, the pieces began to come together.

With the cycle complete, participants recognized a larger picture of themselves as educational leaders and of their connection to the world through anticipation, “the opposite of control,” and reflection. Without the use of technology, however, we assert this experience would not have happened. Kelly agrees:
Technology, it turns out, was a significant piece of this experience. It gave me something I would never have thought to ask for: solitude. The chat room gave me the loneliest and most profound professional experience of my life. It took away the task. It took away the politics and power structure. It took away work culture and environment. There was no history and no future. Expectations were gone for all who shared the space. I brought only one thing into the chat room: me. The only things I could take away were connections and relationships. But I walked out as alone as the day I walked in. I cannot imagine another way to bring an experience down to the most essential of human interactions.

Thus, while this exemplar provides the evidence from only one case, it can be said that the Experiential Simulations evoked for/in Kelly the three stages of radical transformation. She became deeply dissatisfied with her leadership practices, was intensely inspired to alter her practices, and reflected that her foundational, ontological beliefs were altered to the degree of rebirth. She beautifully expressed these stages:
One would be hard pressed to tell me that what I was doing was not working. A book could not have informed me, a class of relative strangers could not have confronted me, and rich philosophical discussion would not have enlightened me. Nor could I have produced it, orchestrated it, manipulated or demanded it on my own. I had to drown in it . . . . While the door to my office provided a clear escape route, the chat space did not. I could confess to my husband, seek out my cohort and rally my supporters at work; but I could not find a way out of the rising waters of the chat room.
In the end, it took this technology to stop time and space. I can imagine nothing else that could strip me of the power of intellect and ego. This technology called on my heart for answers. It was in coming up empty handed that I was faced with the challenge of a lifetime: developing relationships that require more humor than sarcasm, that can get things done better than I can do them on my own and generate power I have yet to imagine. That [original emphasis] journey has just begun.
   Notes:
   1. Portions of this discussion are taken from Brunner, Hitchon, & Brown, (2002).
   2. It is not the intent of this chapter to review the literature on “transformational leadership.” For a brief, yet fairly comprehensive summary, see Leithwood and Jantzi (1999). On page 453, for example, they write:
Current educational leadership literature offers no unitary concept of transformational leadership. Kowalski and Oates (1993), for instance, accept Burns' (1978) original claim that transformational leadership represents the transcendence of self-interest by both leader and led. Dillard (1995)prefers Bennis'(1959) modified notion of “transformative leadership—the ability of a person to reach the souls of others in a fashion which raises human consciousness, builds meanings and inspires human intent that is the source of power” (p. 560). Leithwood (1994) used another modification of Burns, this one based on Bass's (1985) two-factor theory in which transactional and transformational leadership represent opposite ends of the leadership continuium. Bass maintained that the two actually can be complementary. Leithwood (1994) identified six factors that make up transformational leadership. Hipp and Bredeson (1995), however, reduced these factors to five in their analysis of the relationship between leadership behaviors and teacher efficacy. Gronn (1996) noted the close relationship, in much current writing, between views of transformational and charismatic leadership, as well as the explicit omission of charisma from some current conceptions of transformational leadership.
   3. Small portions of the discussion in this section are taken verbatim from Brunner, Hitchon, and Brown (2002).

### REFERENCES

Anderson, G. L. (1998). Toward authentic participation: Deconstructing the discourses of participatory reforms in education. American Educational Research Journal, 35 (4), 571-603.
Bass, B. M. (1985). Leadership and performance beyond expectations. New York: The Free Press.
Beck, L., & Murphy, J. (1997). Ethics in educational leadership programs: Emerging models. Columbia, Mo.: University Council of Educational Administration, Inc.
Campbell, R. F., Fleming, T., Newell, L. J., & Bennion, J. W. (1987). A history of thought and practice in educational administration. New York: Teachers College Press.
Bennis, W. G. (1959). Leadership theory and administrative behavior: The problem of authority. Administrative Science Quarterly, 4, 259-260.
Brunner, C. C. (2002). Professing Educational Administration: Conceptions of Power (Three Parts). Journal of School Leadership, 12, 693-720.
Brunner, C. C., Hitchon, W. N. G., & Brown, R. (2002). Advancing social justice as a part of educational leadership development: The potential of imaging technologies. On The Horizon, 10(3), 12-15.
Burns, J. (1978). Leadership. New York: Harper & Row.
Cambron-McCabe, N. (1993). Leadership for democratic authority. In J. Murphy (Eds.), Preparing tomorrow's school leaders: Alternative designs (pp. 157-176). University Park, Pa.: University Council for Educational Administration.
Cooper, B. S., & Boyd, W. L. (1987). The evolution of training for school administrators. In J. Murphy & P. Hallinger (Eds.), Approaches to administrative training (pp. 3-27). Albany, N.Y.: State University of New York Press.
Culbertson, J. A. (1964). The preparation of administrators. In D. E. Griffiths (Ed.), Behavioral science in educational administration (Sixty-third NSSE yearbook, Part II, pp. 303-330). Chicago: University of Chicago Press.
Delpit, L. (1994). Other people's children: cultural conflict in the classroom. New York: New Press.
Dewey, J. (1934). Art as experience. New York: Perigree.
Dillard, C. B. (1995). Leading with her life: An African-American feminist (re)interpretation of leadership for an urban high school principal. Educational Administration Quarterly, 31, 539-563.
Farquar, R. H. (1977). Preparatory programs in educational administration. In L. L. Cunningham, W. G. Hack, & R. O. Nystrand (Eds.), Educational administration: The developing decades (pp. 329-257). Berkeley, Calif.: McCutchan.
Glass, T. E. (Ed.), (1986). An analysis of texts on school administration 1820-1985. Danville, Ill.: Interstate.
Gregg, R. T. (1969). Preparation of administrators. In R. L. Ebel (Ed.), Encyclopedia of educational research (4^{th} ed., pp. 993-1004). London: MacMillan.
Griffiths, D. E. (1988). Educational administration: Reform PDQ or RIP. (Occasional paper, no. 8312). Tempe, Ariz.: University Council for Educational Administration.
Griffiths, D. E., Stout, R. T., & Forsyth, P. B. (1988). The preparation of educational administrators. In D. E. Griffith, R. T. Stout, & P. B. Forsyth (Eds.), Leaders for America's schools: The report and papers of the National Commission on Excellence in Educational Administration (pp. 284-304). Berkeley, Calif.: McCutchan.
Gronn, P. (1996). From transactions to transformations: A new world order in the study of leadership. Educational Management and Administration, 24(1), 7-30.
Hallinger, P., Leithwood K., & Murphy, J. (1993). Cognitive perspectives on education leadership. New York: Teachers College Press.
Heifetz, R. A., & Laurie, D. L. (1997). The work of leadership. Harvard Business Review, 75(1), 124-134.
Henry, M. (1996). Parent-school collaboration: Feminist organizational structures and school leadership. Albany, N.Y.: State University of New York Press.
Hipp, K. A., & Bredeson, P. V. (1995). Exploring connections between teacher efficacy and principals' leadership behaviors. Journal of School Leadership, 5(2), 136-150.
Kahne, J. (1994). Democratic communities, equity, and excellence: A Deweyan reframing of educational policy analysis. Educational Evaluation and Policy Analysis, 16(3), 233-248.
Kohn, A. (1998). Only for my kid: How privileged parents undermine school reform. In Phi Delta Kappan, 79(8), 569-577.
Kopernik, A., Tuleweit, W., Wingbermuehle, J., & Weik, S. (1997). 3D-speaker-modeling for new videoconferencing services: Templates vs. adaptive triangulation. ITG-Fachberichte, 143, 671-3.
Kowalski, J., & Oates, A. (1993). The evolving role of superintendents in school-based management. Journal of School Leadership, 3(4), 380-390.
Lambert, L. (1998). Building leadership capacity in schools. Alexandria, Va.: Association for Supervision and Curriculum Development.
Larson, C. L., & Ovando, C. J. (2001). The color of bureaucracy: The politics of equity in multi-cultural school communities. Belmont Calif.: Wadsworth/Thompson Learning.
Leithwood, K. (1994). Leadership for school restructuring. Educational Administration Quarterly, 30(4), 498-518.
Leithwood, K., & Duke, D. L. (1999). A century's quest to understand school leadership. In J. Murphy & K. S. Louis (Eds.), Handbook of research on educational administration: A project of the American Educational Research Association (pp. 45-72). San Francisco: Jossey-Bass Publishers.
Leithwood, K., & Jantzi, D. (1999). Transformational school leadership effects: A replication. School Effectiveness and School Improvement, 10(4), 451-479.
Lipman, P. (1997). Restructuring in context: A case study of teacher participation and the dynamics of ideology, race, and power. American Educational Research Journal, 34, 3-37.
Malen, B. (1994). Enacting site-based management: A political utilities analysis. Educational Evaluation and Policy Analysis, 16(3), 249-267.
Malen, B., & Ogawa, R. (1988). Professional-patron influence on sit-based governance councils: A confounding case study. Educational Evaluation and Policy Analysis, 10(4), 251-70.
Malen, B., Ogawa, R. T., & Kranz, J. (1990). What do we know about school-based management? A case study of the literature—a call for research. In W. H. Clune & J. F. Witte (Eds.), Choice and control in American education, Vol. 2: The practice of choice, decentralization and school restructuring (pp. 289-342). New York: Falmer Press.
Mann, D. (1974). The politics of administrative representation: School administrators and local democracy. Lexington, Mass.: Lexington Books.
Massaro, D. W., Cohen, M. M., Daniel, S., & Cole, R. A. (1998). Developing and evaluating conversational agents. WECC 98. Workshop on embodied conversational characters. Palo Alto, Calif.: FX Palo Alto Lab.
McCarthy, M. M. (1999a). How are school leaders prepared: Trends and future directions. Educational Horizons, 1, 74-81.
McCarthy, M. M. (1999b). The evolution of educational leadership preparation programs. In J. Murphy & K. Seashore-Louis (Eds.), Handbook of research on educational administration: A project of the American Educational Research Association (pp. 119-139). San Francisco: Jossey-Bass.
Moore, H. A. (1964). The ferment in school administration. In D. E. Griffiths (Ed.), Behavioral science and educational administration (Sixty-third NSSE yearbook, Part II, pp. 11-32). Chicago: University of Chicago Press.
Morishima, S., Aizawa, K., & Harashima, H. (1990). A real-time facial action image synthesis system driven by speech and text. Proceedings of the SPIE—The International Society for Optical Engineering, 1360 Part 2, 1151-8.

Murphy, J. (1990). Preparing school administrators for the twenty-first century: The reform agenda. In B. Mitchell & L. L. Cunningham (Eds.), Educational leadership and changing contexts of families, communities, and schools (Eight-ninth NSSE yearbook, Part II, pp. 232-251). Chicago: University of Chicago Press.
Murphy, J. (1991). The effects of the educational reform movement on departments of educational leadership. Educational Evaluation and Policy Analysis, 13(1), 49-65.
Murphy, J. (1992). The landscape of leadership preparation: Reframing the education of school administrators. Newbury Park, Calif.: Corwin Press, Inc.
Nadler, D. A., & Tushman, M. L. (1995). Types of organizational change: From incremental improvement to discontinuous transformation. In D. A. Nadler, R. B. Shaw, A. E. Walton, & Associates. Discontinuous change: Leading organizational transformations (pp. 15-34). San Francisco: Jossey-Bass Publishers.
Newmann, F. M., King, M. B., & Rigdon, M. (1997). Accountability and school performance: Implications from restructuring schools. Harvard Educational Review, 67, 41-74.
Oakes, J. (1985). Keeping track: How schools structure inequality. New Haven, Conn.: Yale University Press.
Ogawa, R. (1994). The institutional sources of educational reform: The case of school-based management. American Educational Research Journal, 31, 519-548.
Paige, R. (2003). Note from the Editor-in-Chief. Architectural Digest: The International Magazine of Interior Design, 60(2), 38.
Peebles, L. D. (2000). Millennial challenges for educational leadership: Revisiting issues of diversity. In P. M Jenlink & T. J. Kowalski (Eds.), Marching into a new millennium: Challenges to educational leadership (pp. 190-211). Lanham, Md.: Scarecrow Press, Inc.
Peterson, K. D., & Finn, C. E. (1985). Principals, superintendents and the administrator's art. The Public Interest, 79, 42-62.
Popkewitz, T. (1979). Schools and the symbolic uses of community participation. In C. Grant (Ed.), Community participation in education (pp. 114-139). Boston: Allyn & Bacon.
Reitzug, U. C., & Capper, C. (1996). Deconstructing site-based management: Possibilities for emancipation and alternative means of control. International Journal of Educational Reform, 5(1), 56-59.
Schank, R. C. (2002). Are we going to get smarter? In J. Brockman (Ed.), The next fifty years: Science in the first half of the twenty-first century, (pp. 206-15). New York: Vintage Books.
Scott, S. D., & Leong, S. T. (2000). Combining expressions and speech in talking head models. Challenges of Information Technology Management in the 21^{st} Century. Information Resources Management Association International Conference (pp. 707-8). Hershey, Pa.: Idea Group Publishing.
Silver, P. F. (1982). Administrator preparation. In H. E. Mitzel (Ed.), Encyclopedia of educational research (5^{th} ed., Vol. 1, pp. 49-59). New York: Free Press.
Tabor, J. (1997, July-September). Talking heads. IEEE-Multimedia, 4 (3), 81-3.
Weiler, H. (1990). Comparative perspectives on educational decentralization: An exercise in contradiction. Educational Evaluation and Policy Analysis, 12(4), 433-448.
Wohlsetter, P., Smyer, R., & Mohrman, S. A. (1994). New boundaries for school-based management: The high involvement model. Education Evaluation and Policy Analysis, 16(3), 268-286.
Wong, D., Packard, B., Girod, M., & Pugh, K. (2000). The opposite of control: a Deweyan perspective on intrinsic motivation in “After 3” technology programs. Computers in Human Behavior, 16, 313-338.
Wong, D., Pugh, K., & The Dewey Ideas Group at Michigan State University. (2001). Learning science: A Deweyan perspective. Journal of Research in Science Teaching, 38(3), 317-336.
Yammarion, F. J., Dubinsky, A. J., & Spangler, W. D. (1998). Transformational and contingent reward leadership: Individual, dyad, and group level of analysis. The Leadership Quarterly, 9(1), 19-27.
Yukl, G. (1994). Leadership in organizations: Third edition. Englewood Cliffs, N.J.: Prentice-Hall.

1. A method comprising using computerized chat rooms to allow participants to interact with each other without revealing to other participants their true identity, wherein participants are given pseudo identities that are presented to other participants during a training exercise, and wherein the pseudo identities are revealed in one or more stages.
